(19) United States
(12) Patent Application Publication
(10) Pub. No.: US 2004/0145324 A1
(43) Pub. Date: Jul. 29, 2004

(54) Integrated control device for environmental systems

(76) Inventors: Christian E. Ross, Hemlock, MI (US); Sayeed A. Mir, Saginaw, MI (US); Wesley G. Zanardelli, Troy, MI (US); Tomy Sebastian, Saginaw, MI (US); Tom C. Wong, Saginaw, MI (US)

Correspondence Address: CHARLES K. VEENSTRA, Legal Staff-Intellectual Property, M/C 480-410-202, DELPHI TECHNOLOGIES, INC., P.O. Box 5052, Troy, MI, 48007, US

(21) Appl. No.: 10/353,297

(22) Filed: Jan. 28, 2003

(51) Int. Cl. H02P 1/18

(52) U.S. Cl. 318/254

(57) ABSTRACT

An integrated control device for an environmental system comprises a motor that is in mechanical communication with a device forcing fluid through the environmental system and a controller physically mounted to the motor. The controller includes a processor programmed to control the motor and at least one other internal system of said environmental system in response to a thermostat control signal. The other internal system may comprise a heater and/or cooling unit.

### TECHNICAL FIELD

This disclosure relates to environmental systems for heating, ventilation, and/or cooling an environment. More particularly, this disclosure relates to an integrated control device for such systems.

### BACKGROUND

Environmental systems, such as heating, ventilation, and air conditioning (HVAC) systems are used in many commercial and industrial applications, such as in the heating and cooling of buildings. The temperature changing capacity of an environmental system is produced by a heater and/or cooling unit. In the case of heat pumps, the cooling unit and the heater are the same system. A heater can generate heat using, for example, a combustion process, a catalytic process, a refrigeration cycle (e.g., a heat pump), an electrical resistance heating source, and others. Cooling units primarily rely on a refrigeration cycle but other cooling units are known, such as, a thermoelectric devices, evaporative coolers, environmental heat sinks, etc. The environmental system exchanges heat between a fluid, such as air, and the heater and/or cooling unit by forcing the fluid across a heat exchanger, which is in thermal communication with the heater and/or cooling unit.

A blower fan can be used to force the air through the environmental system (e.g., a forced air heating and cooling system). The forced air is supplied from the heat exchanger to desired locations in the building through air passeageways or ducts.

The blower fan is rotated by a blower motor. The blower motor can be a brushless DC motor that is controled by a motor controller. The motor controller comprises a microprocessor configured to operate the blower motor in a known manner. Low cost HVAC systems have a motor controller and motor that are configured to operate the blower motor at a single fixed speed. Medium cost systems have a motor controller and motor that are configured to operate the blower motor at multiple fixed speeds. Higher cost systems have a motor controller and motor that are configured to operate the blower motor at varaible speeds. These different configurations can require different components, wiring, software, and combinations of any of the foregoing.

The environmental system is controlled by a system controller. The system controller recevies inputs including, for example, a control signal from a thermostat. When the system controller determines that heating is desired, the system controller sends an output signal to the heat source to generate heat and sends an output signal to the motor controller. The motor controller then activates and controls the operation of the blower motor. Similarly, when the system controller determines that cooling is desired, the system controller sends an output signal to activate the cooling source and sends an output signal to the motor controller, which activates and controls the operation of the blower motor.

The required communication between the motor, the motor controller, and the system controller can add expense, complexity, and size to the HVAC system.

### SUMMARY

Disclosed herein is an integrated control device for an environmental system comprising a motor that is in mechanical communication with a device forcing fluid through the environmental system and a controller physically mounted to the motor. The controller includes a processor programmed to control the motor and at least one other internal system of said environmental system in response to a thermostat control signal. The other internal system may comprise a heater and/or cooling unit.

### BRIEF DESCRIPTION OF THE DRAWINGS

The present disclosure is described, by way of example, with reference to the accompanying drawings, in which:

FIG. 1 is a block diagram of an exemplary embodiment of an integrated control device;

FIG. 2 is a schematic view of an exemplary embodiment of a gas furnace having an integrated control device; and

FIG. 3 is a perspective view of an exemplary embodiment of the integrated control device of FIG. 2 connected in driving relation to a blower.

### DETAILED DESCRIPTION

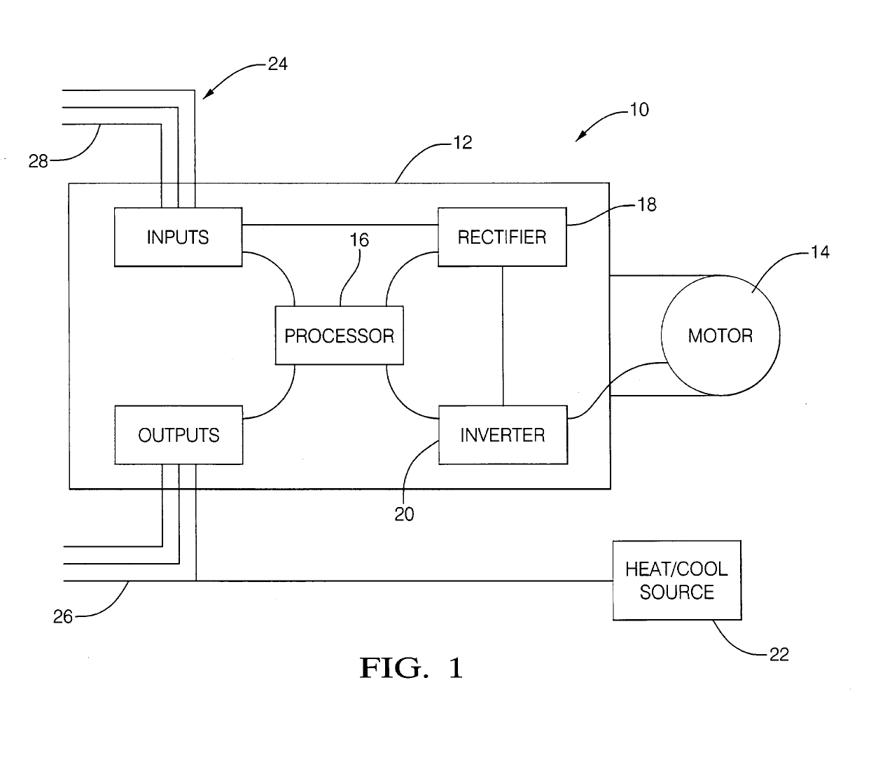

Referring now to the Figures and in particular to FIG. 1, an integrated control device 10 for an environmental system is illustrated. Device 10 is configured to integrate an environmental system controller, a motor controller, and a blower motor into a single, simple, and inexpensive unit. Thus, device 10 can reduce the size, expense, and complexity of the environmental system.

Integrated control device 10 comprises a controller 12 integrated as part of a motor 14. Controller 12 comprises a processor 16, a rectifier 18, and an inverter 20. Motor 14 is, for example, a brushless DC motor having ferrite magnets. Alternately, motor 14 may be a brushless DC motor having or rare-earth magnets (e.g., neodymium-iron-boron). Motor 14 drives a blower fan (not shown) that moves air across a heating/cooling source 22.

Device 10 is configured such that the controller 12 can receive a plurality of inputs 24 and can provide a plurality of outputs 26 to control the operation of motor 14, source 22, as well as other portions of the environmental system.

Inputs 24 may include an input 28 of for power input (e.g., DC or 110/220 volt AC), thermostat inputs, inputs from the heat cooling source, and other inputs necessary for the control and operation of the environmental system.

Outputs 26 may include a power output to a thermostat (e.g., 24 volt AC), a DC power output to motor 14, one or more activation signals to source 22, and other outputs necessary for the control and operation of the environmental system.

Processor 16 may be a digital signal processor, microprocessor and/or other assorted electronic components well known in the field of electronic control for providing memory, input/output, and processing functions. Processor 16 is programmed to control the operation of the motor 14.

If Input 28 is 110/220 Volt AC, rectifier 18 and/or other components are configured to convert 110/220 Volt AC power to DC power. Rectifier 18 thereby provides the DC power to processor 16 and motor 14, as well as other portions of the environmental system. In an alternative embodiment, input 28 is AC or DC power from an external transformer or other type of power supply.

Inverter 20 is a switching mechanism (e.g., MOSFET type transistors) configured to selectively apply the DC voltage from the rectifier 18 to the various windings of the motor 14. Thus, inverter 20 is coupled between the rectifier 18 and the motor 14. The inverter is controlled by processor 16 to selectively supply the DC voltage across the motor windings to operate the motor.

Accordingly, device 10 comprises controller 12 integrated into motor 14 and uses inputs 24 and outputs 26 to control the operation of the motor and source 22. Specifically, integrated control device 10 integrates the functions of a system controller, a motor controller, and a blower motor into a single, simple, and inexpensive unit.

In addition, device 10 provides the three classes of prior systems (i.e., single fixed speed systems, multiple fixed speed systems, and varaible speed systems) with only a change in software settings. This allows the same device 10 to provide all three classes of systems, which can further reduce the cost of the environmental system.

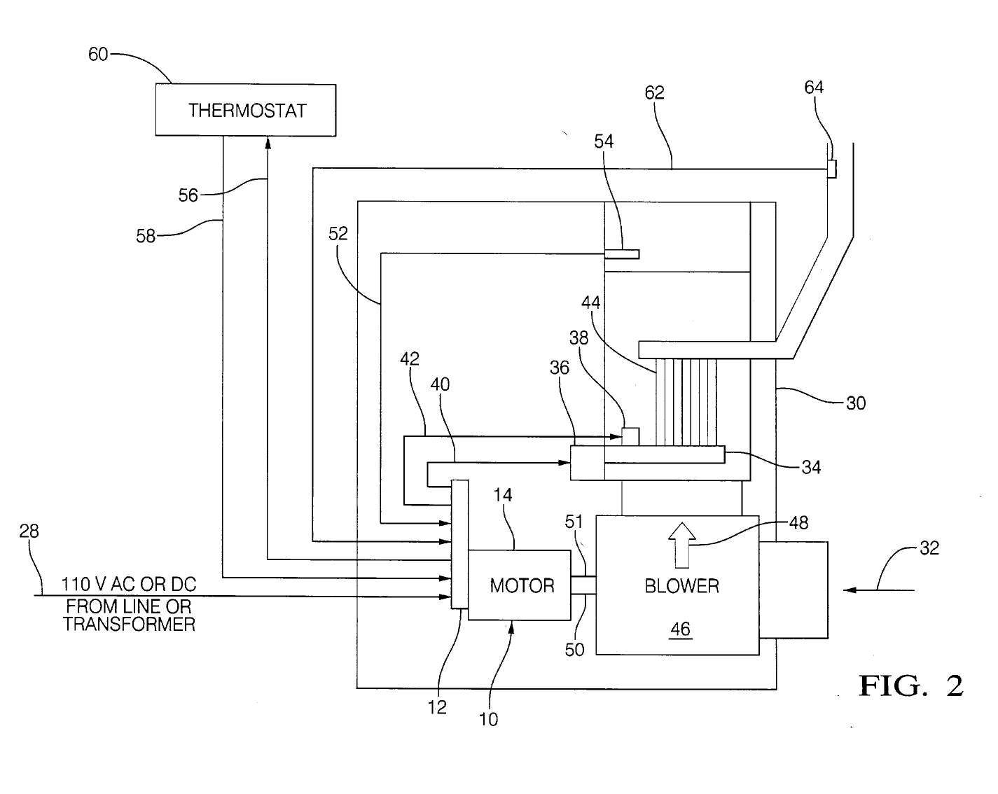

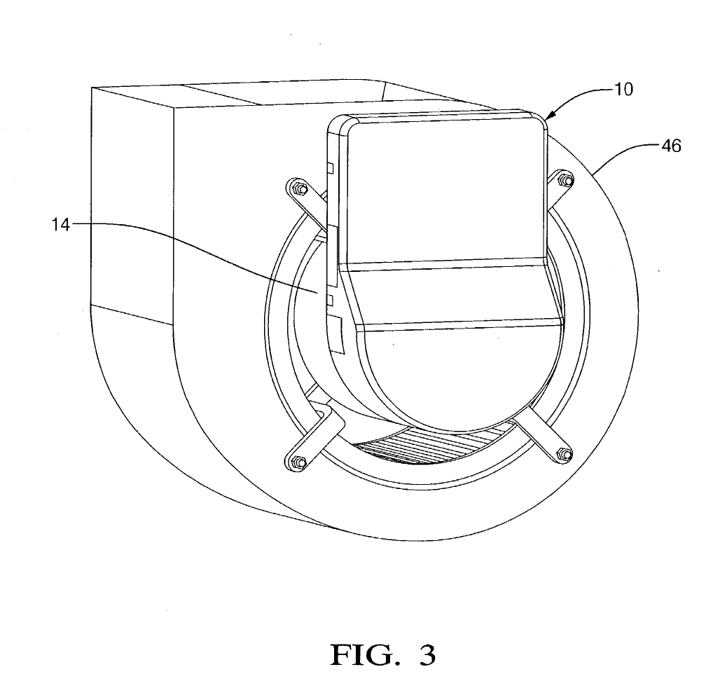

Turning now to FIGS. 2 and 3, device 10 is illustrated by way of example in use with a gas furnace 30. Gas furnace 30 comprises a gas source (not shown) feeding a plurality of burners 34 (only one shown). A solenoid operated gas valve 36 is positioned between the gas source and burners 34. Gas valve 36 is configured to selectively supply a desired mixture of gas and air to burners 34. Each burner 34 includes an igniter 38 adapted to selectively ignite the mixture. Device 10 is configured to provide a first output 40 to control the operation of gas valve 36 and a second output 42 to control the operation of igniters 38.

Gas furnace 30 also comprises a plurality of heat exchangers 44 in convective and/or conductive communication with the burners 34 such that the combustion of the mixture heats the heat exchangers. Supply air for the combustion process enters the gas furnace 30 and the by-products of the combustion process exit the furnace in a desired manner. For example, the by-products of the combustion process exit the furnace through an exhaust flue. In addition, an exhaust gas blower (not shown) can be configured to aid in venting the combustion by-products from gas furnace 30.

Gas furnace 30 also comprises a blower fan 46 in fluid communication with heat exchangers 44. Blower fan 46 is configured to force a fluid, such as air, through heat exchangers 44 in the direction of arrow 48. Specifically, motor 14 is configured to rotate a motor shaft 50, which drives blower fan 46 through a transmission 51. Transmission 51 may comprise a belt and pulley system, a chain and sprocket system, a gear train system, and others to drive blower fan 46. As shown, motor 14 is directly connected to blower fan 46 by shaft 51; thus shaft 50 is transmission 51.

It should be recognized that gas furnace 30 is described herein by way of example as an up-flow gas furnace. Of course, other types of furnaces using heating sources other than combustion and/or furnaces that force the air in other directions through the heat exchangers are contemplated by the present disclosure.

Device 10 is configured to receive a first input 52 from a thermister 54, which is provided on the heat exchangers 44 or elsewhere in the system. Input 52 is indicative of the temperature of the air after it has been forced through heat exchangers 44.

Device 10 is also configured to provide a third output 56 and to receive a second input 58 from a thermostat 60. Thermostat 60 may be positioned in a desired location in the building in which gas furnace 30 is installed. Thermostat 60 is a switching device that receives third output 56 from device 10, and sends second input 58 back to the device when the thermostat detects one or more selected conditions.

Third output 56 and second input 58 are, for example, control voltage signals (e.g., 24 volts AC). Thermostat 60 is configured to measure the ambient temperature in the building in which gas furnace 30 is installed. An operator adjusts a desired target temperature-using thermostat 60. Thermostat 60 provides second input 58 to device 10 when the thermostat determines additional heat is needed to maintain the target temperature.

Upon receiving second input 58, device 10 starts gas furnace 30 to provide heat to the building. Specifically, integrated control device 10 activates motor 14 to operate blower fan 46. Device 10 sends first output 40 to gas valve 36, which opens the valve and provides the gas supply 32 to the burners 34. Additionally, integrated control device 10 sends second output 42 to igniters 38 to ignite the mixture in burners 34.

Integrated control device 10 can continuously monitor first input 52 from thermister 54 while gas furnace 30 is operating. Device 10 may control the speed of the blower fan, the state of the gas valve, and/or the number of burners in operation to manage the air temperature exiting the heat exchangers 44 to a desired temperature.

Thermostat 60 stops sending second input 58 to device 10 when the thermostat heat is no longer required to maintain the target temperature.

Device 10 stops gas furnace 30 when second input 58 is no longer provided by thermostat 60. Specifically, integrated control device 10 deactivates motor 14 to stop blower fan 46. Device 10 stops sending first output 40 to the gas valve 36, which closes the valve and shuts off gas supply 32 to burners 34. In this example, gas valve 36 is normally biased to a closed position such that the removal of first output 40 causes the valve to open (e.g., a normally closed valve). Of course, other types of valves are contemplated for use with the present disclosure. For example, integrated control device 10 may send a second first output signal 40 to close gas valve 36 (a two-way actuated valve).

Integrated control device 10 may also be configured to receive a third input 62 from an exhaust gas pressure sensor 64. Third input 62 can be indicative of a pressure of the combustion by-products in an exhaust vent or flue. Device 10 can modify, adjust, or suppress the operation of the gas furnace based upon third input 62. For example, integrated control device 10 can control the pressure in the exhaust vent by turning on and off or modifying the speed of an exhaust gas fan 66, which aids in venting the combustion by-products from gas furnace 30, by closing gas valve 36 to one or more burners 34, and others.

Accordingly, and in this manner integrated control device 10 is configured to maintain the ambient temperature in the building to a desired level. It should be recognized that the operation of gas furnace 30 by integrated control device 10 is described above by way of example only. Of course, integrated control device 10 can operate gas furnace 30 using more than, less than, and/or different inputs and outputs than those described above. For example, integrated control device 10 may receive inputs a flame sensor, a current shunt voltage resistor, and others. Device 10 may provide outputs to an exhaust fan (not shown), a humidifier (not shown), etc.

Integrated control device 10 eliminates the wiring harness between the system controller and the motor controller, and between the motor controller and the motor of prior systems. Thus, the high level of integration provided by integrated control device 10 reduces the number of components, which can provide a corresponding increase in reliability.

It should also be noted that the terms “first”, “second”, and “third” may be used herein to modify elements performing similar and/or analogous functions. These modifiers do not imply a spatial, sequential, or hierarchical order to the modified elements, unless otherwise indicated.

While the invention has been described with reference to one or more an exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An integrated control device for an environmental system, comprising:
a motor, said motor being in mechanical communication with a device forcing fluid through said environmental system;
a controller physically mounted to said motor, said controller including a processor programmed to control said motor and at least one other internal system of said environmental system in response to a thermostat control signal, said at least one other internal system comprising at least one of a heater and a cooling unit.

2. The integrated control device as in claim 1, wherein said motor is a brushless DC motor and said device forcing fluid is a blower, said fluid being environmental air.

3. The integrated control device as in claim 2, wherein said controller further comprises a rectifier and an inverter, said rectifier being configured to convert an AC power input to DC power, said rectifier being configured to provide said DC power to said processor and said inverter, wherein said inverter is controlled by said processor to selectively supply said DC power to said motor to operate said motor in said first state.

4. The integrated control device as in claim 3, wherein said processor includes software selectable so that said motor is controlled to one of a single fixed speed, multiple fixed speeds, and varaible speeds.

5. The integrated control device as in claim 3, wherein said processor is a digital signal processor programmed to control the operation of said motor and said at least one other internal system.

6. The integrated control device as in claim 1, said controller receiving signals from one or more of a thermostat, said at least one other internal system, a temperature sensor sensing temperature of said air after it has been heated or cooled by said environmental system, and a flue pressure sensor.

7. The integrated control device as in claim 1 wherein said at least one other internal system comprises a furnace, said control device being programmed to operate said motor, an exhaust fan, a gas valve, an ignitor, and a humidifier in response to signals from a thermostat, an exhaust gas pressure sensor, a flame sensor, and a current shunt voltage resistor.

8. The integrated control device of claim 7 wherein said controller is further programmed to optionally command said motor to run at one of a single speed, multiple fixed speeds, and infinitely variable speeds.

9. A gas furnace, comprising:
an integrated control device including a processor fixed to a motor, said integrated control device being configured to receive a plurality of inputs;
a source of a flammable gas;
a burner;
a valve being movable between a first position and a second position, said flammable gas being provided to said burner when said valve is in said first position, said flammable gas not being provided to said burner when said valve is in said second position;
an igniter positioned adjacent said burner, said igniter being configured to ignite said flammable gas and cause combustion of said flammable gas;
a heat exchanger in thermal communication with said burner such that said combustion heats said heat exchanger; and
a blower being driven by said motor, said blower being in fluid communication with said heat exchangers, said motor being operable in a range defined by a first state and a second state, said blower causing a fluid to flow through said heat exchanger when said motor is operating, wherein said processor, in response to said plurality of inputs, controls said valve, said igniters, and said motor.

10. The gas furnace as in claim 9, wherein at least one of said plurality of inputs is a signal from a thermostat.

11. The gas furnace as in claim 9, wherein said processor includes software configured to operate said motor in one of a single fixed speed, multiple fixed speeds, and varaible speeds.

12. The gas furnace as in claim 9 wherein said plurality of inputs includes a pressure signal indicative of a pressure of by-products of said combustion in an exhaust system, said integrated control device being configured to control said pressure based upon said pressure input.

13. The gas furnace as in claim 12, wherein said integrated control device controls said pressure by at least one of modifying a speed of an exhaust gas fan disposed in said exhaust system, controlling said valve, adjusting a speed of said motor, and any combination of the foregoing.

14. The gas furnace as in claim 9, wherein said plurality of inputs includes a thermister input indicative of a temperature of said fluid after it has flowed across said heat exchanger.

15. The gas furnace as in claim 14, wherein said integrated control device controls said temperature of said fluid by any one of controlling said valve, adjusting a speed of said motor, and any combination of the foregoing.

16. The gas furnace as in claim 9, wherein said motor is a brushless DC motor having ferrite magnets or rare-earth magnets.
